(19) United States
(12) Patent Application Publication
(10) Pub. No.: US 2019/0012601 A1
(43) Pub. Date: Jan. 10, 2019

(54) INFORMATION VISUALIZATION METHOD FOR USER GROUP DECISION MAKING, AND USER TERMINAL USING SAID METHOD, OPERATION METHOD OF SERVER PROVIDING INFORMATION FOR USER GROUP DECISION MAKING, AND SERVER APPARATUS USING SAID METHOD

(71) Applicant: Sung Soo HONG, Uijeongbu-si (KR)

(72) Inventors: Sung Soo HONG, Uijeongbu-si (KR); Min Hyang SUH, Daegu (KR)

(21) Appl. No.: 15/952,249

(22) Filed: Apr. 13, 2018

(30) Foreign Application Priority Data
Jul. 10, 2017 (KR) 10-2017-0086992

(51) Int. Cl. G06N 5/02; G06F 17/30

(52) U.S. Cl. CPC G06N 5/02; G06F 17/30979

(57) ABSTRACT

Provided is a method for a user terminal to visualize information for making a decision in a user group. The method includes inputting a selection range of a first user of the user terminal over at least one criterion related to the decision-making, receiving information about selection ranges over at least one criterion related to the decision-making of other group members in the user group, extracting a filtered selection range by performing filtering based on at least one of the first user's selection range and the information about other group members' selection ranges; extracting candidates for decision-making that match the filtered selection range, and visually presenting the extracted candidates for decision-making. And at least one of the preferences for the visually presented candidates and the selection ranges over at least one criterion may be visually presented by matching with each group member.

### CROSS-REFERENCE TO RELATED APPLICATIONS

This application claims the benefit of priority of Korean Patent Application No. 10-2017-0086992 filed on Jul. 10, 2017, all of which are incorporated by reference in their entirety herein.

### BACKGROUND OF THE INVENTION

### Field of the invention

The present invention relates to an information visualization method and, more particularly, to a user interface-based information visualization method for providing support to facilitate decision making.

### Related Art

With the spread of smartphones in recent years, smartphones are more and more often used at situations where many participants need to make a decision, such as when choosing a restaurant, a café, a bar, or a hiking trail. That is, a smartphone can act as a moderator in situations requiring group decision-making.

However, most of the conventional methods for choosing a specific destination with a smartphone require that group members get together in a chat room and reach consensus by talking about places they want to go to, as in usual chats. Alternatively, the group members can decide on where to go by hearing whether they agree or not with a specific destination if a certain group member uploads a link to this destination. That is, when selecting an item from among a plurality of decision candidates in a system for group decision-making, each individual in the group looks up items, shows their findings to other participants in decision making, and asks them whether they agree or not. However, in such an information search system, it is difficult to take everyone's preferences into account in decision-making, and it is hard for people to understand why recommended items are selected and shared unless the person who recommends the items explains the reason explicitly. To make a decision which everyone in decision-making can agree with, the group members need to talk in explicit language, which usually takes a considerable amount of time and effort.

### SUMMARY OF THE INVENTION

The present invention provides an information visualization method, apparatus, and system for user group decision-making, that extract candidates based on each member's own preference range by filtering and visually present the candidates by matching with each group member, in order to enable a user group including a plurality of group members to make a decision.

According to one aspect of the present invention, there is provided a method for a user terminal to visualize information for making a decision in a user group including a plurality of group members, the method including: inputting a selection range of a first user of the user terminal over at least one criterion related to the decision-making; receiving information about selection ranges over at least one criterion related to the decision-making of other group members in the user group; extracting a filtered selection range by performing filtering based on at least one of the first user's selection range or the information about other group members' selection ranges to perform filtering; extracting candidates for decision-making that match the filtered selection range; and visually presenting the extracted candidates for decision-making, wherein at least one of the preferences for the visually presented candidates and the selection ranges over at least one criterion may be visually presented by matching with each group member.

The information visualization method may further include sending information about the first user's selection range selected with input from the first user to at least one of other group members' terminals and the server.

The first user's selection range over at least one criterion may be changed while presenting information about the selection ranges of at least some of the group members over at least one criterion.

A filter used for filtering may include at least one among: a first filter for filtering the candidates within the first user's selection range; a second filter for filtering candidates that match the selection ranges of all the group members participating in decision-making; and a third filter for presenting every candidate that matches at least one of the selection ranges of the group members participating in decision-making.

The server or the first user may select the filter used for filtering.

The group members participating in the decision making may be assigned corresponding visual representations, and the selection ranges over at least one criterion may be displayed in a bar shape based on the corresponding visual representations.

A selection range a plurality of group members select over a specific criterion may be displayed in one bar, wherein the one bar may be indicated with a visual representation that indicates a scent based on the number of group members for each range.

The group members participating in the decision making may be assigned corresponding visual representations, and the preferences on the candidates may be presented by marking the corresponding visual representations near the candidates.

An interface for selecting a criterion over which the first user of the user terminal hides the selection range from other group members' terminals may be provided.

An interface for choosing group members to allow the first user to show or hide the selection range over at least one criterion to or from the terminals of the group members may be provided.

A plurality of group members included in a first user group for making a first decision may be organized by sending an invitation message and accepting the invitation.

The first user group is a user group for making a first decision, one user of which is associated with a plurality of user groups for making multiple decisions, and the plurality of user groups associated with the one user may be presented in a list.

The preferences on the candidates may be presented in a list view or map view.

In the map view, the preferences on the candidates may be indicated by a cluster bubble.

The selection range may include at least one among a Boolean selection range, a categorical selection range, and a quantitative selection range.

According to another aspect of the present invention, there is provided an apparatus for visualizing information for making a decision in a user group including a plurality of group members, the apparatus including: an input unit that inputs a selection range of a first user of the user terminal over at least one criterion related to the decision-making; a communication unit that receives information about selection ranges over at least one criterion related to the decision-making of other group members in the user group; a controller that extracts a filtered selection range based on the first user's selection range and the information about other group members' selection ranges and extracting candidates for decision-making that match the filtered selection range; and a display unit that visually presents the confirmed candidates, wherein at least one of the preferences for the candidates and the selection ranges over at least one criterion may be visually presented by matching with each group member.

According to yet another aspect of the present invention, there is provided an operation method of a server providing information for making a decision in a user group including a plurality of group members, the method including: receiving each group member's selection range from the user terminals of the plurality of group members over at least one criterion related to the decision-making; extracting a filtered selection range by performing filtering based on information about at least one of the selection ranges of the plurality of group members; extracting candidates for decision-making that match the filtered selection range; and providing the extracted candidates for decision-making to the terminal of at least one of the plurality of group members through the communication unit, wherein at least one of the preferences for the candidates and the selection ranges over at least one criterion may be visually presented by matching with each group member.

According to a further aspect of the present invention, there is provided a server apparatus for providing information for making a decision in a user group including a plurality of group members, the sever apparatus including: a communication unit that receives each group member's selection range from the user terminals of the plurality of group members over at least one criterion related to the decision-making; a filter that extracts a filtered selection range by performing filtering based on information about at least one of the selection ranges of the plurality of group members; and a decision-making event manager that extracts candidates for decision-making that match the filtered selection range, wherein the extracted candidates for decision-making may be provided to the terminal of at least one of the plurality of group members through the communication unit, and at least one of the preferences for the candidates and the selection ranges over at least one criterion may be visually presented by matching with each group member.

### BRIEF DESCRIPTION OF THE DRAWINGS

FIG. 1 is a conceptual diagram conceptually showing a system to which an information visualization method for user group decision-making according to an exemplary embodiment of the present invention.

FIG. 2 is a block diagram schematically showing an information visualization apparatus for user group decision-making according to an exemplary embodiment of the present invention.

FIG. 3A is an illustration exemplifying information presented on a screen according to an information visualization method for user group decision-making according to an exemplary embodiment of the present invention.

FIGS. 3B to 3E are illustrations exemplifying selection range information presented on a screen according to an information visualization method for user group decision-making according to an exemplary embodiment of the present invention.

FIGS. 4A to 4C are illustrations of an operation method of filters that can be used.

FIG. 5 is an illustration exemplifying how candidates are shown in a list according to an information visualization method for user group decision-making according to an exemplary embodiment of the present invention.

FIG. 6 is an illustration exemplifying how candidates are shown on a map according to an information visualization method for user group decision-making according to an exemplary embodiment of the present invention.

FIGS. 7A and 7B are illustrations exemplifying a method of efficiently presenting multiple users' selection ranges.

FIG. 8 is an illustration exemplifying a method of distinguishing who agree or disagree with a specific candidate.

FIG. 9 is an illustration exemplifying a display screen showing a chat screen as well.

FIG. 10 is an illustration exemplifying a main screen of a device where an information visualization method for user group decision-making according to an exemplary embodiment of the present invention is implemented.

FIG. 11 is an illustration exemplifying a screen for creating a group after logging in through the main screen of FIG. 10.

FIG. 12 is an illustration exemplifying a display screen that is shown when a group member receives an invitation message.

FIG. 13 is an illustration exemplifying a display screen that displays a list of events related to a specific user.

FIG. 14 is an illustration exemplifying an interface for setting up a specific event.

FIG. 15 is an illustration exemplifying an interface for selecting whether to show or hide the user's own selection range and to whom to show.

FIG. 16 is an illustration exemplifying an interface for choosing group members when the user wants to view selection ranges of only some of the group members in a specific event.

FIG. 17 is a block diagram schematically showing a configuration of a server apparatus of an information visualization system for user group decision-making according to an exemplary embodiment of the present invention.

FIG. 18 is a view showing a summary view (also referred to as a simple view) screen of an information visualization method for user group decision-making according to another exemplary embodiment of the present invention.

FIG. 19 is a view showing a screen (also referred to as a detail view) that appears when there is a request to show details on a specific dimension in the summary view screen of FIG. 18.

FIG. 20 is a view exemplifying ping cue messages.

### DESCRIPTION OF EXEMPLARY EMBODIMENTS

The present invention may have various modifications and various embodiments and specific embodiments will be illustrated in the drawings and described in detail in the detailed description.

However, this does not limit the present invention to specific embodiments, and it should be understood that the present invention covers all the modifications, equivalents and replacements included within the idea and technical scope of the present invention.

Terms including as first, second, and the like are used for describing various constituent elements, but the constituent elements are not limited by the terms. The terms are used only to discriminate one constituent element from another component. For example, a first component may be referred to as a second component, and similarly, the second component may be referred to as the first component without departing from the scope of the present invention. A term ‘and/or’ includes a combination of a plurality of associated disclosed items or any item of the plurality of associated disclosed items.

When it is described that a component is “connected to” or “accesses” another component, the component may be directly connected to or access the other component or a third component may be present there between. In contrast, it should be understood that, when it is described that an element is “directly connected to” or “directly access” another element, it is understood that no element is present between the element and another element.

Terms used in the present application are used only to describe specific embodiments, and are not intended to limit the present invention. A singular form may include a plural form if there is no clearly opposite meaning in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

If it is not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

Exemplary embodiments of the present invention will be described in detail below with reference to the accompanying drawings. In the following description of the embodiments, the same reference numerals are assigned to the same elements throughout the drawings and also redundant descriptions of the same elements are omitted, in order to facilitate the overall understanding of the embodiments.

In this specification, decision-making includes a decision-making process for making collaborative suggestions and reaching consensus. Also, an event may be defined as a unit of consensus for making a decision on a specific destination, and therefore one consensus may correspond to one event. Preferably, two or more group members participate in one event.

Moreover, a so-called selection range may include, but is not necessarily limited to, a Boolean selection range (e.g., parking availability or whether vegetarian options are provided), a categorical selection range (e.g., restaurant type), and/or a quantitative selection range (e.g., the price range of the restaurant).

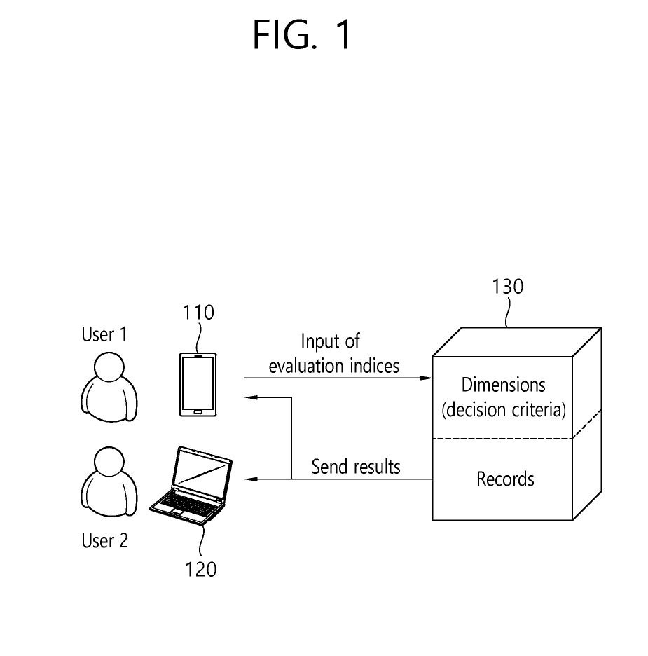

FIG. 1 is a conceptual diagram conceptually showing a system to which an information visualization method for user group decision-making according to an exemplary embodiment of the present invention. As shown in FIG. 1, the system according to the exemplary embodiment of the present invention may include a plurality of user terminals 110 and 120 and a server 130.

Referring to FIG. 1, the plurality of user terminals 110 and 120 may connect with each other through a wireless and/or wired network and also connect with the server 130. The plurality of user terminals 110 and 120 are devices with a communication function and an information input function, which form a specific group to support decision making within the group. To support decision making, the plurality of user terminals 110 and 120 input information about their preferences on multiple decision criteria by using a faceted browsing application and dynamic queries (DQ). The input preference information is shared between them, and the group members in the user group may make a decision based on the shared preference information.

The plurality of user terminals 110 and 120 may be aware of each other's preferences on a specific criterion for decision-making by running the same or similar applications playing the role of visualizing data.

At least one evaluation index (or referred to as decision criteria associated with decision-making) the user terminal 110 inputs in relation to preference information may be set directly or provided from the server 130. In this case, decision criteria may be preset by default on the server 130. Alternatively, the decision criteria may be changed based on information provided from the user terminal 110, and information related to these decision criteria may be provided via the server or directly to the terminals of other group members. A plurality of decision criteria may be used when making a decision—that is, multi-dimensional decision criteria may be used. A dimension may refer to a separate selection range for a specific decision criterion.

One of the plurality of user terminals 110 and 120 may generate an event for decision-making by inviting users with whom to discuss decision making to a user group, and may proceed with the decision making process by sharing selection ranges over decision criteria with the group members within the generated event.

The plurality of user terminals 110 and 120 may receive directly or via the server 130 information about selection ranges over decision criteria that are associated with a plurality of group members (including themselves).

Then, candidates for decision-making that match the group members' selection ranges may be extracted based on the received selection range information. In this case, filtering may be required. A plurality of filters may be used for filtering, and the user themselves may choose one of them. Filtering may be done via the user terminal 110 or the server 130. When filtering is performed via the server 130, the user terminal 110 may receive filtered selection information from the server 130.

Once filtering is completed, the user terminals 110 and 120 extract candidates related to decision-making that match a filtered selection range. Alternatively, such candidate information may be received from the server 130.

Then, the extracted candidates for decision-making may be presented on the user terminals 110 and 120. There are various methods for presentation. In order for an application on each terminal to act as a moderator in decision-making, quantitative ranges selected by other group members are presented by matching with the corresponding group members, and candidates matching a filtered selection range of the group members are also presented by matching with the corresponding group members. Thus, it is possible to intuitively know which selection range a specific group member selects over which decision criterion and which member of the group is associated with which candidate.

The user terminals 110 and 120 may easily change the screen by relating a decision-making-related display function with a map and/or navigation function, and they have a chat function to allow group members participating in decision-making to adjust their opinions more efficiently while identifying the selection ranges and candidates selected by each group member. That is, applications running on the user terminals 110 and 120 provide support to enable everyone in the user group or most of them to share their opinions efficiently to make a decision. This may be called group awareness. For instance, an application according to an exemplary embodiment of the present invention may run with a technology that efficiently presents on a screen who agrees with a specific candidate but disagrees with other candidates over a specific decision criterion. In addition, members may adjust the decision making of their own and/or of at least some group members' in an interactive way until a decision is finalized, while viewing how other group members' decision making is going on. In this way, they can reach a final decision by adjusting their candidates. In such instances, it is not a trivial matter for each member to track the dynamically changing preferences of others, and a decision-making information visualization method according to an exemplary embodiment of the present invention uses an approach that is most suitable for deploying a moderator. A human (here, the human may refer to the user of a specific user terminal) or a non-human agent that acts as a moderator plays the following roles:

Role 1: A moderator aggregates preferences over a set of decision criteria of a group and surfaces them to members.

Role 2: A moderator provides information about the candidates that match with individual and group preferences, and helps a group to identify if there is a feasible candidate that could lead to a decision.

Role 3: In case there is no agreement, a moderator facilitates group consensus by identifying the sources of disagreement and suggests preferences to relax so that agreement can be reached within a group.

More specifically, a decision-making information visualization apparatus according to an exemplary embodiment of the present invention includes a visualization tool for accomplishing the role of a moderator. The user terminals 110 and 120 which run such a tool allow a single user to enter a set of preferences over multiple decision criteria (by using slider widgets), and visualize a set of iteratively matching candidates. Also, they extend their functionality for use in collaborative decision-making contexts to perform the above three roles. To this end, first, the user terminals 110 and 120 of each group member indicate their own preferences (also referred to as quantitative preference ranges) over decision criteria via a plurality of slider widgets. Then, they share information related to the preferences with other group members in the user group. Then, a system presents visual cues that show which candidates are within whose preferences-on-criteria.

According to an exemplary embodiment of the present invention, the user terminals 110 and 120 are equipment with communication functionality, and may be referred to as a mobile station (MS), a user equipment (UE), a user terminal (UT), a wireless terminal, an access terminal (AT), a terminal, a fixed or mobile subscriber unit, a subscriber station (SS), a wireless device, a wireless communication device, a wireless transmit/receive unit (WTRU), a mobile node, a mobile, a mobile station, a personal digital assistant (PDA), a smart phone, a laptop, a netbook, a personal computer, a wireless sensor, a consumer electronic device (CE), or other terms. Various embodiments of the user terminals 110 and 120 may include a cellular phone, a smart phone having a wireless communication function, a personal digital assistant (PDA) having a wireless communication function, a wireless modem, a portable computer having a wireless communication function, a photographing device such as a digital camera having a wireless communication function, a gaming device having a wireless communication function, home appliances for music storage and playback having a wireless communication function, internet-connected home appliances capable of wireless internet access and browsing, and portable units or terminals that integrate combinations of the functions, but are not limited thereto.

The server 130 is a device connected to the plurality of mobile terminals 110 and 120 by a wired and/wireless network, which internally includes a database or is connected to an external database. The server 130 manages browsing applications. Here, the management of the applications may include maintenance and repair of the applications, version upgrade, user management, data log management, etc.

The server 130 stores and manages data received from the plurality of user terminals 110 and 120. The server 130 manages user authentication information in relation to the applications, and manages user log-ins based on the authentication information. Moreover, the server 130 may receive information on selection ranges selected by the user terminals 110 and 120 and manage it as records. Further, the server 130 manages events related to the user terminals 110 and 120, and manages corresponding decision criteria in relation to the events. The decision criteria may be preset, and the settings may be changed upon a request from the user terminals 110 and 120. Information about decision criteria suitable for each event may be provided to the user terminals 110 and 120, and the user terminals 110 and 120 may select selection ranges that match their own preferences based on the provided decision criteria information. Information about the selected selection range is recorded on the server 130, and the server 130 provides information about group members who participate in the corresponding event to the user terminals 110 and 120 of the group members. Although the figures disclose that there are only two user terminals 110 and 120, the number of group members in a group is not limited to this and there may be three or more or even ten or more group members. Upon a filtering request from a user, the server 130 may filter the information about the selection ranges provided by the user terminals 110 and 120. Accordingly, the server 130 itself may extract candidates matching filtered selection range information and provide it to the user terminals 110 and 120. In this case, the server 130 itself may store traffic information, geographical information, and various information dealt with by various types of portals or get this information via communication with other servers, and may extract candidates matching a filtered selection range based on this information. For example, if a specific group member's selection range indicates “10-minute distance from region A”, the time of arrival may be calculated based on geographical information and real-time traffic information, and candidates located within that distance may be selected and then provided to the user terminals 110 and 120.

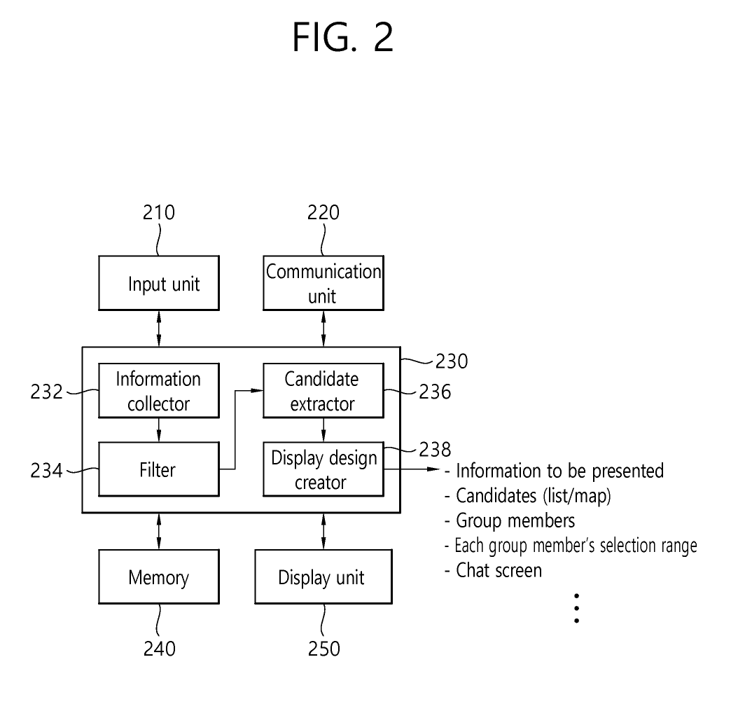

FIG. 2 is a block diagram schematically showing an information visualization apparatus for user group decision-making according to an exemplary embodiment of the present invention. As shown in FIG. 2, a user terminal according to an exemplary embodiment of the present invention may include an input unit 210, a communication unit 220, a controller 230, a memory 240, and a display unit 250.

The input unit 210 is a component, such as a keyboard, a mouse, a touchscreen, or a touch pad, that allows a user to input information. The input unit 210 receives input from the user, corresponding to an interface that is provided to the user through the display unit 250 and requires the user to select, and input information is sent to the controller 230. Through the input unit 210, the user may select a decision-making category (e.g., a hiking trail, a restaurant (and types of food), a meeting place, etc.) they want and selection range information that matches a selected type of decision making.

The communication unit 220 includes a communication processor for sending and receiving information to and from the server and/or other user terminals, and may largely include a transmitter and a receiver. The communication unit 220 may include an antenna unit for wireless communication and a component for wired communication as well. The communication unit 220 may provide the controller 230 with information received from the server and/or other user terminals.

The controller 230 may include an information collector 232, a filter 234, a candidate extractor 236, and a display design creator 238.

The information collector 232 collects information received from the server or other group members' terminals via the communication unit 220 and information input by the user. The user input information includes a decision-making category, and decision criteria corresponding to the decision-making category may be provided by default. The user selects at least one selection range over the provided decision criteria, and selected information is collected through the information collector 232. For instance, the decision criteria are related to the quality of a destination, and may include review ratings, price range, the number of reviews, travel time, and distance to the destination. In this case, the travel time and the distance to the destination are calculated with respect to one place of departure if everyone in the user group departs from the same location. However, if they all depart from different locations, the travel time and the distance to the destination are calculated with respect to a plurality of departure places by identifying the current location of each individual group member's departure place (which may be given upon input of account information or by finding the current location of each group member's terminal via GPS functionality). A more complicated approach may be needed.

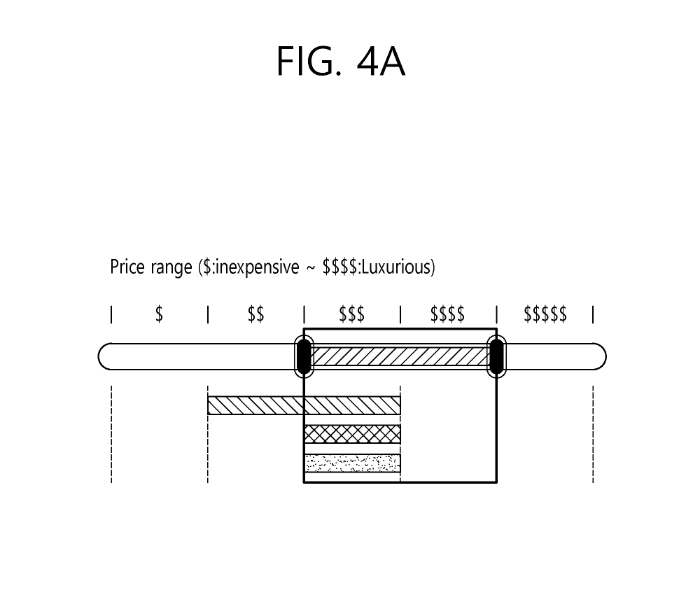

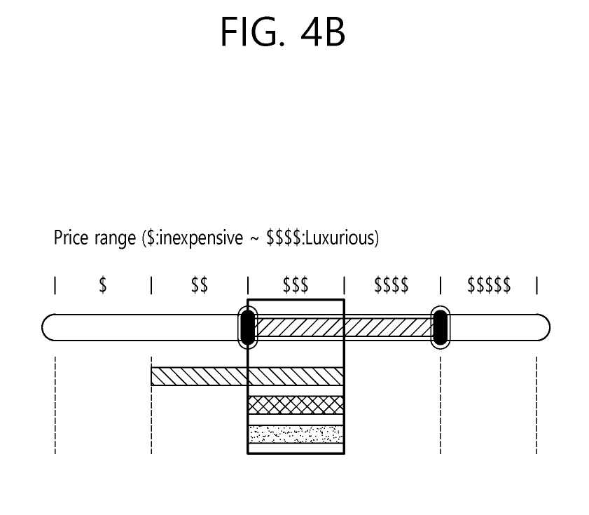

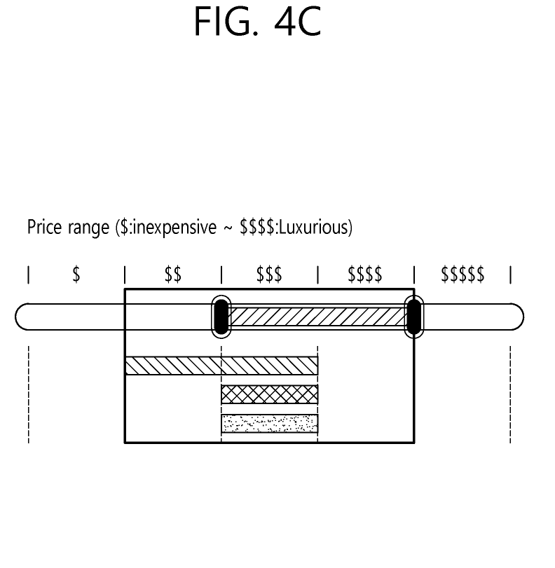

The filter 234 filters selection information the user indicates over a plurality of decision criteria and selection information other group members select over at least some of the plurality of decision criteria. A filter that can be selected by the user includes: an ego-centered filter, a group-exclusive filter, and a group-inclusive filter. This will be described in more details with reference to FIGS. 4A to 4C.

The candidate extractor 236 extracts candidates that match selection information that is filtered by the filter 234 over the plurality of decision criteria. The candidates may be extracted based on maps and other various data stored in the memory 240. Alternatively, the candidates that match the decision criteria may be found and extracted based on various information received from a server (which may be a server different from the server of FIG. 1) connected by a wireless and/or wired network. Alternatively, the candidates may be extracted based on information received from the server of FIG. 1. The candidate extractor 236 extracts a final candidate by analyzing a vast amount of information regarding the candidates. Information to be considered includes review ratings of candidates, geographical information (including coordinates information), type information (restaurants or hiking trails and types of cuisine), elevation, prices of items, the number of reviews, the rate of being selected as candidates, and so on. Candidates may be extracted by matching such various information with the filtered selection range. For example, if the filtered selection range in terms of price is from [symbol] 10,000 to [symbol] 20,000, candidate restaurants serving cuisines at these prices may be matched and extracted. Next, whether the candidate restaurants extracted within the price range match information about a filtered selection range over other criteria or not is another issue to be dealt with later. That is, if there are multiple criteria, it is desirable to find a candidate that matches all the criteria. The extracted candidates will differ depending on whether a selection range is applied to one criterion or multiple criteria.

According to another exemplary embodiment of the present invention, the user terminal may not include the filter 234 and/or the candidate extractor 236. That is, if the user terminal sends a filtering request to the server, based on information on the type of a selected filter, filtering and/or candidate selection can be done on the server, and filtered results and/or candidate results may be received from the server and visually displayed.

The display design creator 238 creates visualization information that is to be presented through the display unit 250, based on user-input settings information. Information to be presented may include candidates, group members, selection ranges each group member selects over decision criteria, and so on. The candidates may be presented in a list, or the list may be switched to a map. Alternatively, the list may be switched to a chat screen.

Moreover, candidates and selection ranges may be presented in association with each group member. That is, they may be designed in such a way to collectively show which candidates Group Member 1 agrees on and which selection range they selects over which decision criterion. The layout of candidates, group members, selection ranges, etc. at the top, bottom, left, and right sides of the display may be arbitrarily altered through the user settings.

The memory 240 stores commands for performing a series of operations of the user terminal's application (including a filter) according to an algorithm. Further, it may include user settings information. Also, it may store previous logs related to the user's use of the application. For example, it may store information about selection ranges the user select over specific decision criteria for an event with specific group members and related candidate information. The stored range information may be used later for other events. Also, the memory 240 may store geographical information (including coordinate information, for example), candidate-related information (such as review ratings of candidates, coordinates, types, elevation, etc.).

The display unit 250 outputs visual information created by the display design creator 238. The display unit 250 may include a monitor, an LED or LCD screen, a TV screen, a projector, etc.

According to an exemplary embodiment of the present invention, the information collector 232 may collect GPS location information, and when a selection range is selected over decision criteria related to the distance or travel time to a specific destination, the destination extractor 236 may perform filtering within the selected range, calculate the distance or travel time to candidates in real time based on the current location, and extract candidates that match filtered results.

As explained above, if every group member is present in the same location, the calculation is done once. On the other hand, if the above calculation algorithm is performed on the terminals of group members who are present in different locations, each group member's terminal may share the candidates based on results of calculation made on the distance or travel time from their location. In this case, location information of other group members' terminals may be shared and the distance from them to a specific candidate may be presented. Alternatively, in a case where a filter for providing synchronized filtered results is used (for example, a group-inclusive filter and a group-exclusive filter), if filtering is done on terminals present in Locations A and B within a travel time range of 10 minutes, candidates that are within 10-minute distance from Locations A and B may be matched and shared.

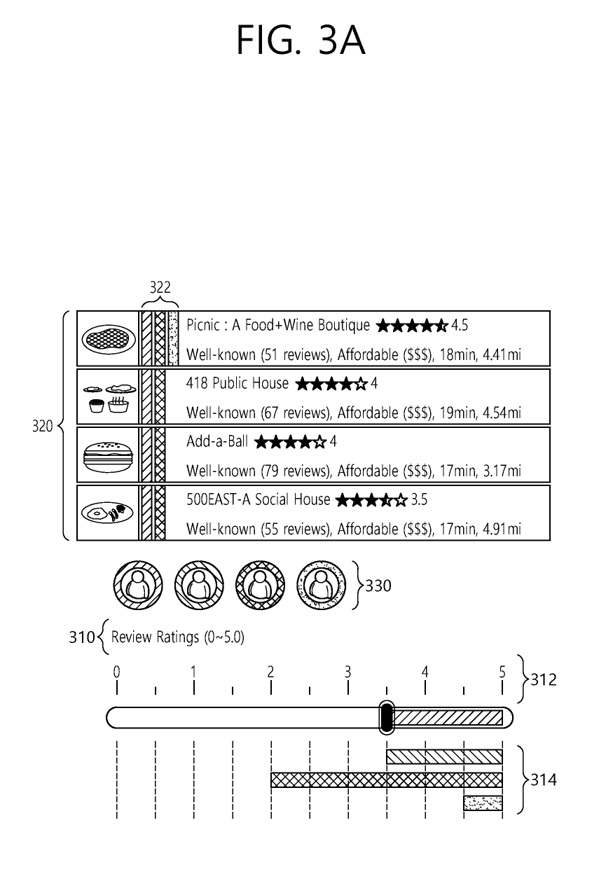

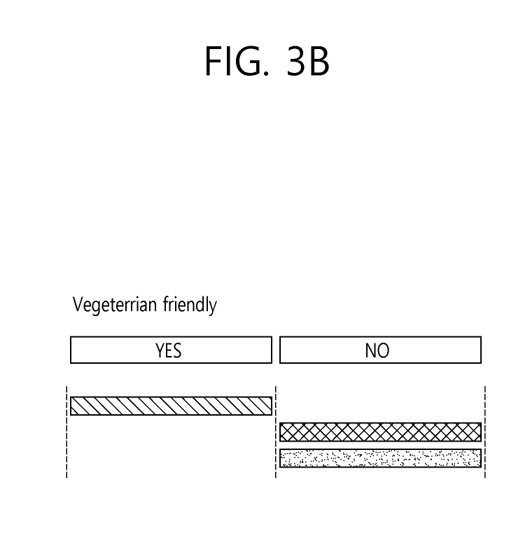

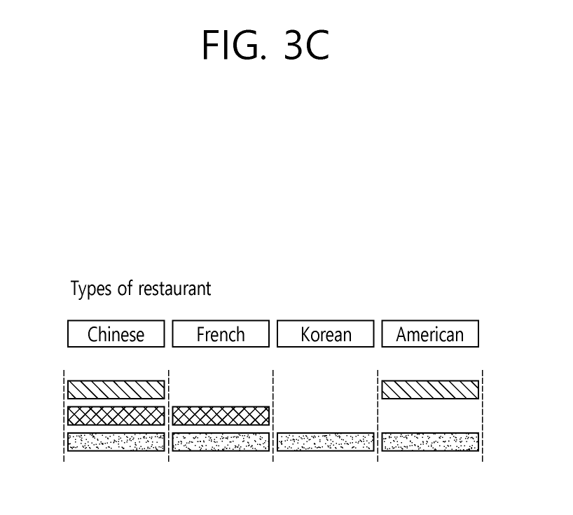

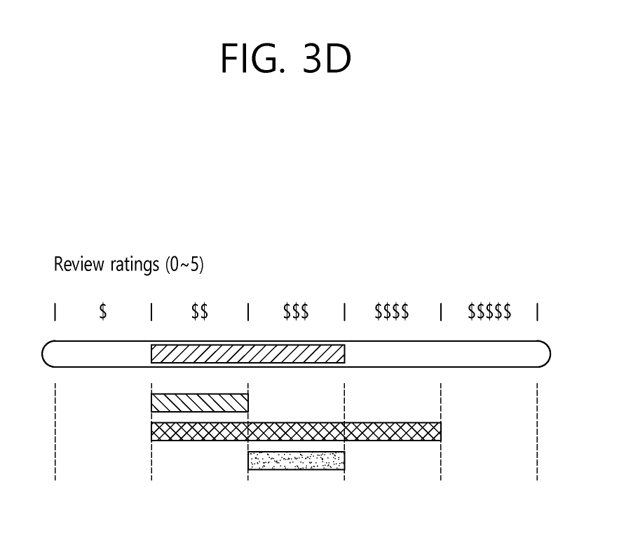

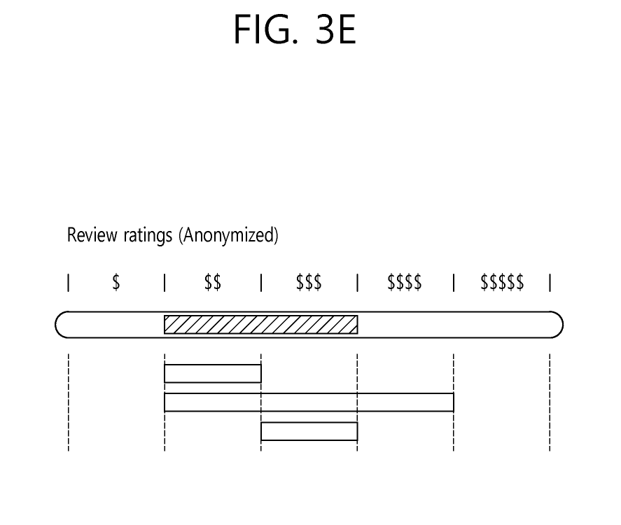

FIG. 3A is an illustration exemplifying information presented on a screen according to an information visualization method for user group decision-making according to an exemplary embodiment of the present invention.

Referring to FIG. 3A, information to be presented on a display screen may include selection ranges 310 over decision criteria, candidates 320, filtered results 312, pre-filtering selection information 314, and group member information 330.

Firstly, the terminal visually presents group members' selection ranges 310 over decision criteria. Assuming that a decision criterion is review ratings, for example, the selection ranges may be from 0 to 5. In this case, the user may select the selection range of 0 to 5. The selection ranges 310 selected by each group member may be identified by visual representations (through hatchings in this exemplary embodiment) distinguished by the group member information 330. That is, the first group member at the left side is a terminal user and selects candidates with review ratings of 3.5 to 5, and the second group member selects review ratings of 4.5 to 5 at the uppermost side in the information 314 presented at the bottom. It is assumed that the third group member selects review ratings of 3 to 5 and the fourth group member selects a narrow range of 4.5 to 5. By presenting the selection ranges of all or some members of the group involved in the event in such a way as to correspond to identification information of the group members, it is possible to clearly see who selects which selection range over a specific decision criterion and to adjust their own selection range in real time based on what other group members select. Also, filtered results are presented at the uppermost side in the selection information. In this exemplary embodiment, ego-centered filtering is done to extract candidates that match the selection range selected by the first group member. Also, in the exemplary embodiment of FIG. 3, the fourth group member may be aware that their own range of review ratings is much narrower than those of the other group members, and may extend their selection range to make a faster decision. In this way, the efficiency of group decision-making may be increased by matching each group member's selection range with their own identifier and visualizing it.

Secondly, the terminal visually presents candidates 320 that match group preferences. The candidates need to be presented as simple as possible. The terminal presents candidates related to a filtered selection range (in this exemplary embodiment, candidates with review ratings of 3.5 to 5 are found by ego-centered filtering). Also, the group members who select selection ranges matching the corresponding candidates are presented on the periphery 322 of these candidates, along with their visual representations, so as to intuitively identify who agrees or disagrees with a specific candidate. Moreover, basic information about a candidate (e.g., the name of the candidate, review ratings, the number of reviews, price range, distance from the departure place, etc.) may be presented as well, and the presented information may be adjusted arbitrarily through the user settings.

Thirdly, the terminal distinguishes each individual group member 330. Each group member's preferences and candidates matching these preferences are presented by matching with their own identifiers to greatly facilitate the decision-making. Therefore, according to the exemplary embodiment of the present invention, the group members 330 participating in this event are presented along with the candidate information 320 and the selection range information 310, and each group member has their corresponding visual representation. The visual representations may be shown in various ways—by colors, figures, and transparency levels of a specific color. By matching the visual representations with the corresponding group members, it is possible to intuitively identify the selection ranges selected by the group members and the candidates related to the group members and to see whether they agree with the candidates or not.

Fourthly, the terminal provides information scents 312 to allow the user to easily decide on candidates. The information scents indicate the distribution of candidates on a selection range. That is, a strong information scent is presented if three people select review ratings of 4 to 4.5, and a weak information scent is presented if only one person selects review ratings of 3 to 3.5. That is, an information scent for a range may be presented corresponding to the number of group members who select the range. Such information scents may be highly influential if there are many group members, and the information scents may be presented in a graph, scents, or colors.

According to the exemplary embodiment of the present invention, the layout of the group member information 330, selection range information 310, and candidate information 320 may be arbitrarily altered through the user settings, and information about other group members' selection ranges are presented below the selection information 310 to allow the user to see the selection ranges of each group member over multiple decision criteria selected by the user or set by default. Also, it is desirable to extract the most agreeable candidate by examining whether the candidates match the multiple decision criteria.

FIGS. 3B to 3E are illustrations exemplifying selection range information presented on a screen according to an information visualization method for user group decision-making according to an exemplary embodiment of the present invention.

FIG. 3B shows dichotomous selection ranges. For instance, they are selection ranges that apply to criteria over which a selection can be made by turning on/off options like parking availability, vegetarian-friendly, etc. In this case, the group members may indicate that they agree or disagree with both of the two options.

FIG. 3C shows categorical selection ranges. For instance, they are selectin ranges that apply to criteria over which at least one can be selected from among various types of options such as Chinese, French, Japanese, Korean, American, etc. For this categorical selection ranges, the group members may indicate their preferences on multiple options.

FIG. 3D shows quantitative selection ranges. For instance, they are selection ranges that apply when indicating preferences on the review ratings, price range, distance, etc. of a particular restaurant. The selection ranges are generally coupled with the corresponding members, but instead member identities may be anonymized by assigning the same identifier to everyone (see FIG. 3E).

FIGS. 4A to 4C are illustrations of an operation method of filters that can be used to present multiple candidates according to user preferences.

Referring to FIG. 4, the terminal may use ego-centered filtering. It is a method of filtering based on a selection range selected by the actual user of the mobile terminal. That is, other group members' selection ranges are presented only for reference, and actual filtering is done based only on the user's own selection range. Ego-centered filtering, when used alone, may be very useful. In this case, data is presented without being synchronized with other group members' filtered data.

Referring to FIG. 4B, the terminal may use group-exclusive filtering. In group-exclusive filtering, candidates that match within everyone's selection ranges are selected. In this case, filtering does not need to be done on everyone in the group but may be done on some of the group members. Group-exclusive filtering may narrow down the candidates. As such, this filtering method is useful to reach consensus, but may narrow the range of choices. Thus, it is desirable to use different filtering methods according to their features. Group-exclusive filtering would synchronize filtered candidates among different group members and present synchronized candidates.

Referring to FIG. 4C, the terminal may use group-inclusive filtering. In group-inclusive filtering, candidates that match within at least one group member's selection range are shown even after filtering. That is, in a case where Group Member 1 selects a range of 1 to 3, Group Member 2 selects a range of 2 to 3, and Group Member 3 selects a range of 2 to 4, group-exclusive filtering provides a range of 2 to 3 whereas group-inclusive filtering provides a range of 1 to 4. As such, group-inclusive filtering filters candidates on a broad scale, and therefore there are many matching candidates. This can widen the range of choices but makes it difficult to reach consensus. With this filtering method, too, synchronized candidates may be provided to everyone in the group. Moreover, group-inclusive filtering does not need to be done on everyone in the group but may be done on some of the group members.

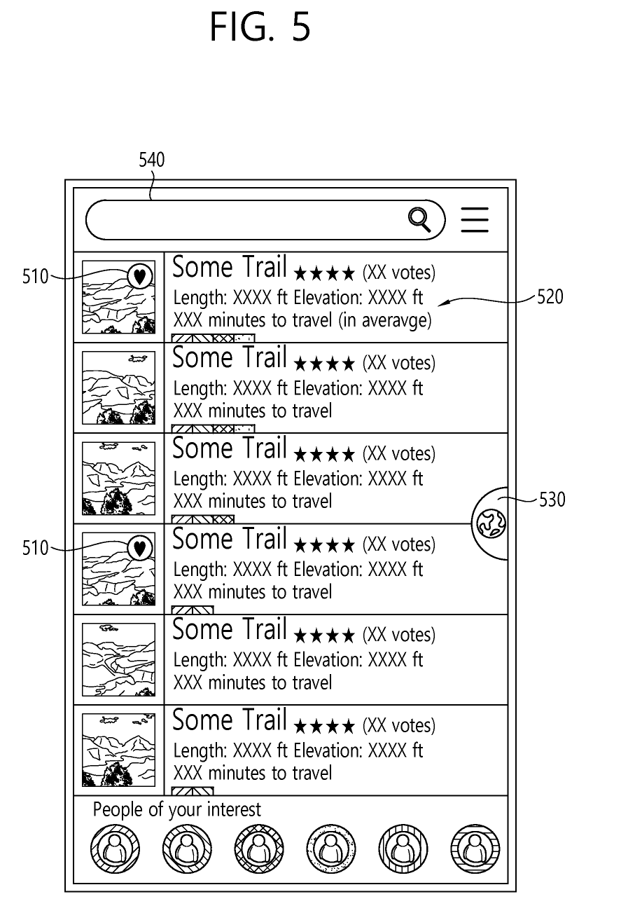

Since filtered results differ depending on the different functions of the above filtering methods, the user may use these filtering methods according to different decision-making situations. Based on the filtered results, the user may alter their own selection range and adjust their opinions. The user may immediately cope with changes in the method of filtering by extracting and presenting the candidates corresponding to the different filters. FIG. 5 is an illustration exemplifying how candidates are shown in a list according to an information visualization method for user group decision-making according to an exemplary embodiment of the present invention.

Referring to FIG. 5, the terminal may present a list of candidates that match within filtered selection ranges. In such instances, heart icons 510 in thumbnails of candidates are icons that can be added to or removed from the favorites. Also, displayed information 520 is basic information related to the corresponding candidate, which may change depending on the type of a destination the user selects for decision-making. That is, information to be displayed when making a decision on hiking and information to be displayed when making a decision on restaurants may be different.

When the globe icon 530 at the right side of the display screen is tapped, a map view is displayed at the top of the screen. That is, this icon is an icon for switching between map and list view. In this case, the map view does not need to be displayed at the top, but the display position may be arbitrarily changed through the user settings.

The search box 540 is a box for entering a search word. By entering a specific search word in the search box 540, candidates related to the search word are presented.

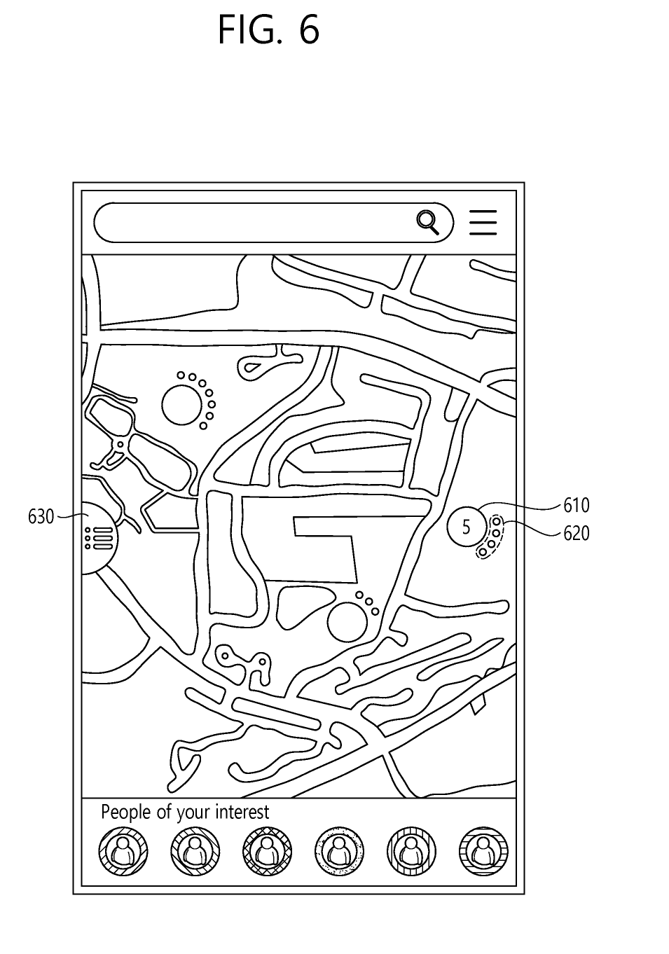

FIG. 6 is an illustration exemplifying how candidates are shown on a map according to an information visualization method for user group decision-making according to an exemplary embodiment of the present invention.

Referring to FIG. 6, candidates presented in a list may be shown on a map as well. Here, a large dot indicated by a number, like the dot 610, is a cluster bubble which may represent the number of group members who agree with the corresponding candidate. The size of the cluster bubble may be proportional to the number of group members who agree with the corresponding candidate.

Moreover, color bars or color circles may be shown around each icon to represent preferences for the corresponding candidate. That is, identifiers of the group members who agree with the corresponding candidate may be shown in color bars or color circles (which may be shown with hatchings, polygons, etc. even if they are not colored) to clearly see on the map the candidates and the group members who agree with them.

Then, the user may go back to the list view screen by tapping the list icon 630 at the left side of the screen.

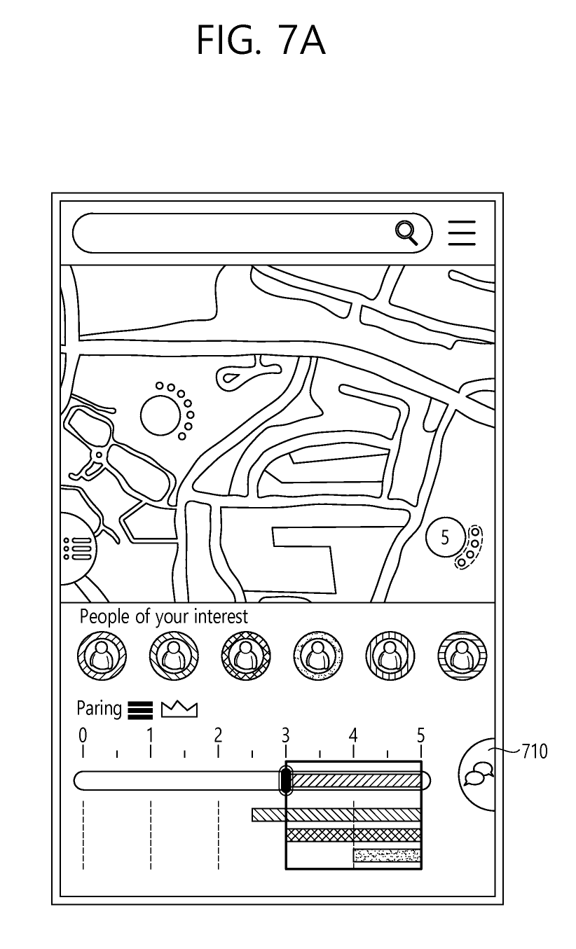

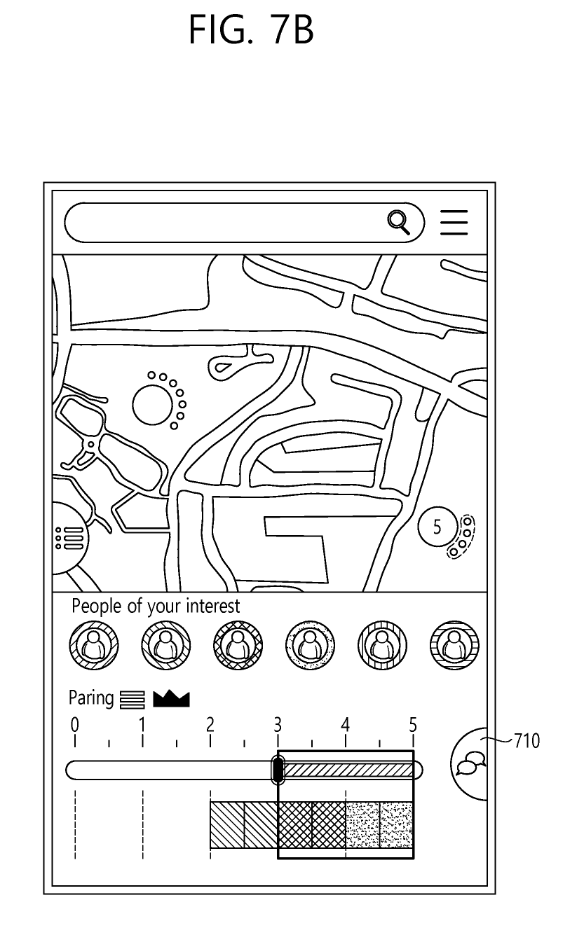

FIGS. 7A and 7B are illustrations exemplifying a method of efficiently presenting multiple users' selection ranges.

Referring to FIG. 7A, the terminal's user may select some group members of their interest among the group members participating in a specific event. That is, the user may only view the selection ranges of people they are interested in or give great credit to by selecting four group members out of a total of ten group members.

Referring to FIG. 7B, the user may display the selection ranges along with summaries of them. That is, percentages indicated on the selection ranges may be displayed in one bar by colors, scents, hatchings, polygons, etc. That is, as many visual representations as the number of group members who select a specific range may be created and represented by scents or the like. According to the exemplary embodiment of the present invention, it can be seen that, out of all the group members, the percentage of people who select a range of 0 to 2 is 20%, the percentage of people who select a range of 2 to 2.5 is 20%, the percentage of people who select a range of 2.5 to 3.5 is 20%, and the percentage of people who select a range of 4 to 5 is 20%.

Also, a chatting user interface may be displayed on the bottom of the screen by clicking the chat icon 710 at the right side.

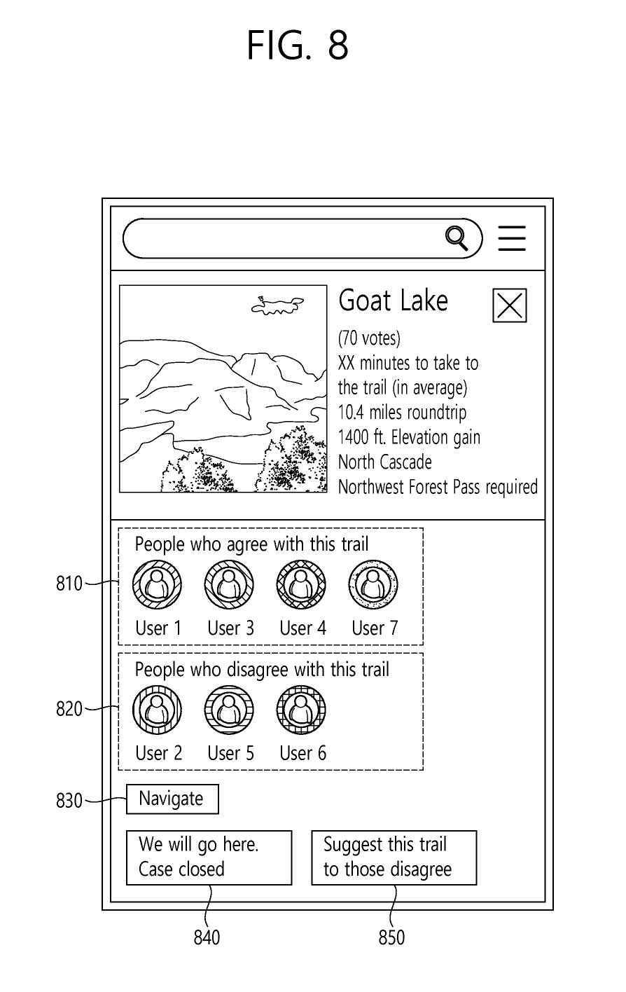

FIG. 8 is an illustration exemplifying a method of distinguishing who agree or disagree with a specific candidate.

Referring to FIG. 8, the terminal may present a view of detailed information about a specific candidate. When the specific candidate is selected, detailed information about the candidate may be presented, and users 810 who agree with this candidate and users 820 who disagree with this candidate may be presented. In this way, each group member is able to easily and intuitively know other group members' opinions related to a specific event.

Moreover, according to an exemplary embodiment of the present invention, the terminal is equipped with a navigation function, displays a navigation route from the current location to the destination by clicking a navigation icon 830, and provide real-time traffic information if the user is driving.

Further, a user group for a specific event may have a leader. The leader may have the authority to finalize a decision on this event. As such, in an interface for a specific candidate, a decision-making icon 840 may be displayed only on the leader's terminal. The server may recognize the leader of the group, and the server may control the decision-making icon 840 to be displayed on the leader's terminal. If the leader selects the decision-making icon 840 while the interface for presenting the decision-making icon 840 is being displayed, the specific candidate is selected for this decision-making event and the case is closed.

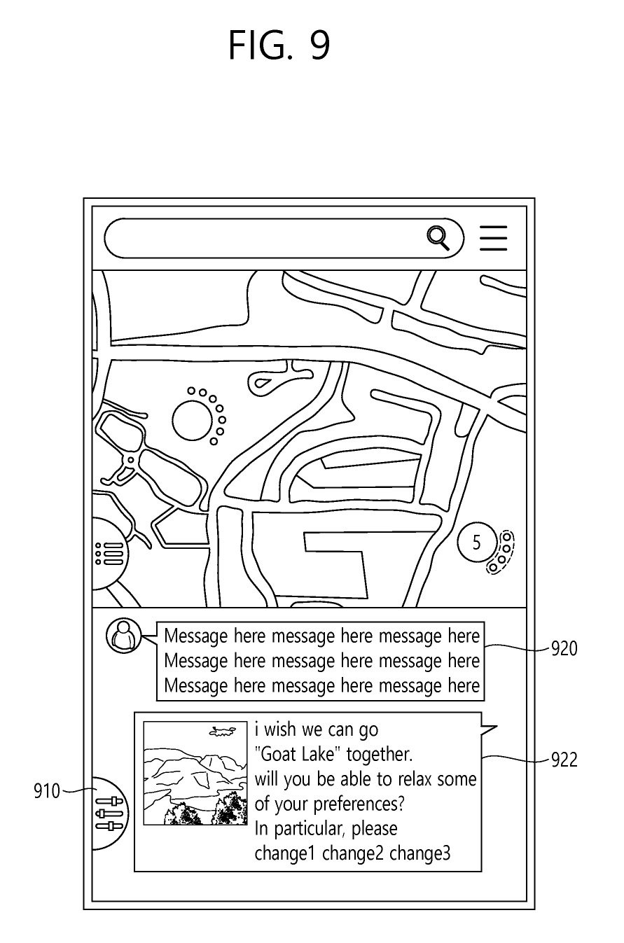

A suggestion icon 850 at the right side of the decision-making icon 840 is an icon that urges those who disagree to send a suggestion message about this candidate. This icon can be used not only by the leader but also by other group members. The screen of FIG. 9s may be displayed by clicking the suggestion icon 850.

FIG. 9 is an illustration exemplifying a display screen showing a chat screen as well.

Referring to FIG. 9, when the chat icon 710 in FIGS. 7A to 7B is clicked, a chat window appears that shows a map view or list view on the top and enables group members to chat. A list view switching icon 910 may be displayed at the left side of the chat window. Alternatively, a map view switching icon may be displayed. Accordingly, the user may switch the window among list, map, and chat immediately when they want.

As explained previously, the second message 920 of FIG. 9 appears when the suggestion icon 850 on the display screen of FIG. 8 is clicked. That is, this message 920 includes suggesting to go to “Goat Lake” and asking those who disagree with this candidate to change their selection ranges to match this candidate.

In this case, change 1, change 2, and change 3 included in the suggestion message 920 may be specified by the user who sends the suggestion message 920. For example, change 1 may be defined as a suggestion to select ratings higher than 3. Change 2 may be defined as a suggestion to select ratings higher than 4.0.

Upon receiving the suggestion message 920, other group members may change their selection ranges over a specific decision criterion immediately by clicking on at least one among change 1, change 2, and change 3.

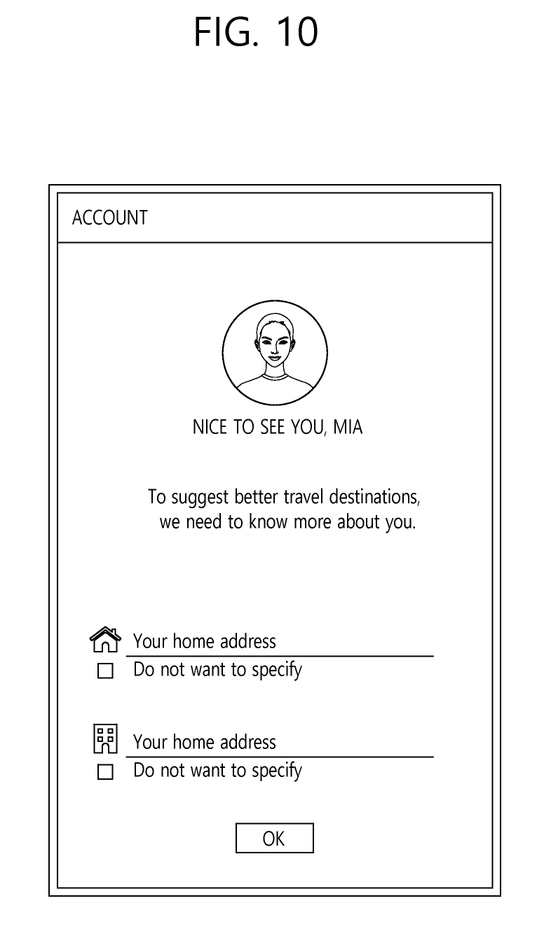

FIG. 10 is an illustration exemplifying a main screen of a device where an information visualization method for user group decision-making according to an exemplary embodiment of the present invention is implemented.

Referring to FIG. 10, when a decision-making application according to an exemplary embodiment of the present invention is executed on the terminal, a screen for creating an account appears. The account may be created using an ID and a password and used to log in to the server. Also, for each account, the home address and the addresses of frequently visited places such as school, office, etc. may be input. This is to keep the user from entering the addresses several times because these places are often used on the terminal when making a decision on a specific destination. A plurality of addresses may be input. Particularly, addresses stored for frequent use may be taken as recent addresses or user-input addresses and managed on the terminal. Accounts and addresses may be shared with the server.

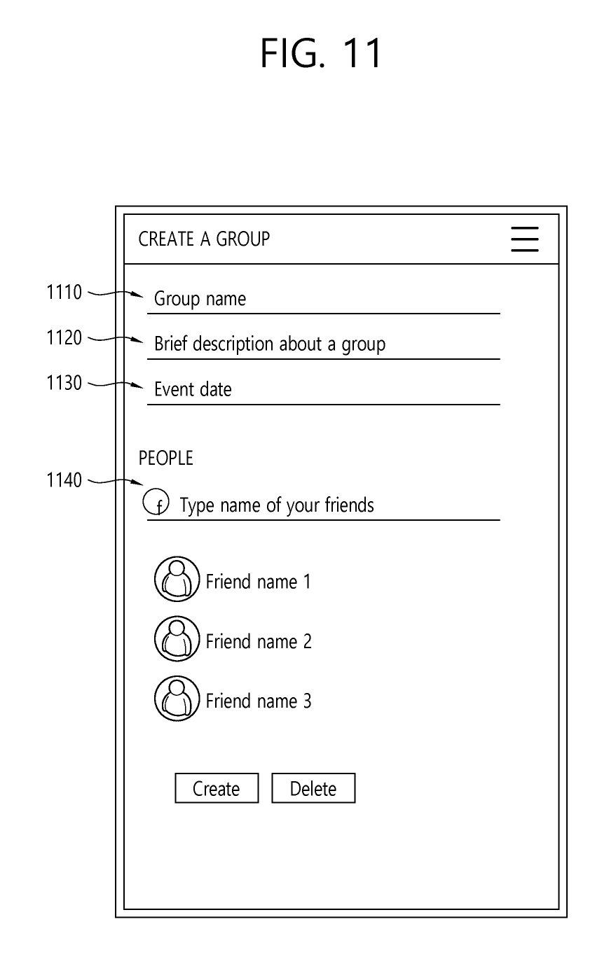

FIG. 11 is an illustration exemplifying a screen for creating a group after logging in through the main screen of FIG. 10.

Referring to FIG. 11, the terminal may select group members to create an event for decision-making after logging in through the main screen. That is, a specific user group may consist of a plurality of group members, and the group members are users who proceed with at least one decision-making event. People who are the group members are eligible for the leader of this group. However, the leader is not necessarily a member of this group but may be a member of another selected group. As explained previously, the leader may have the authority to make a final decision after hearing opinions on a specific destination.

A group name is created in a blank space 1110 to create a group, and a brief description about this group is filled in a blank space 1120. Also, the date of an event related to this group is filled in a blank space 1130. The event date may be the day when decision making is done or a date related to it. For instance, the date of an event related to making a decision on a hiking trail on 27 Aug. 2017 is 27 Aug. 2017.

Then, friends' names are filled in a blank space 1140 to bring group members together. The friends' names are linked to friend lists stored on the terminal or logs of friends stored on the server and may interface with terminal information related to these names. Accordingly, when the user selects a group member, the terminal of the selected group member may provide related information to allow the group member so that they can view it. Then, the group may be created finally through a “Create” icon or deleted through a “Delete” icon.

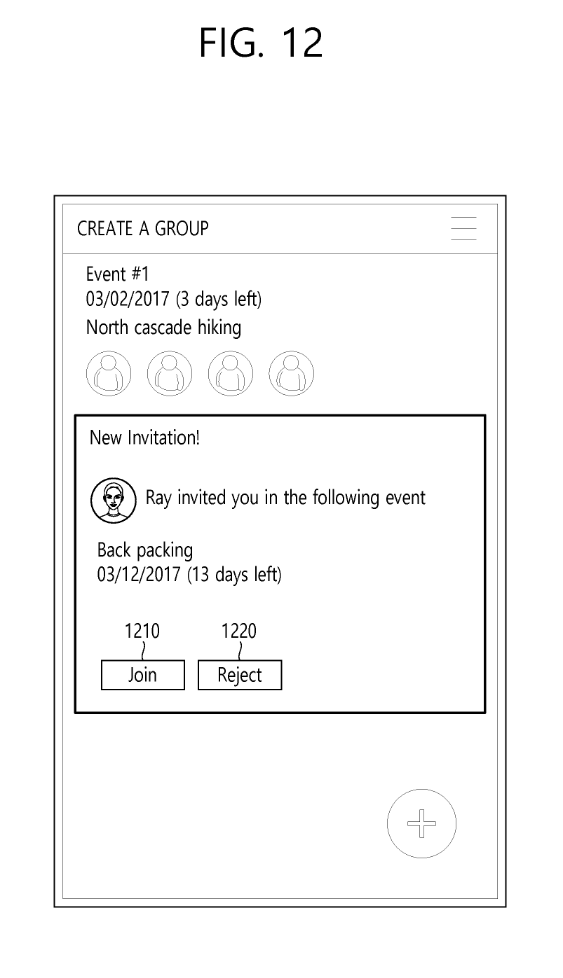

FIG. 12 is an illustration exemplifying a display screen that is shown when a group member receives an invitation message.

Referring to FIG. 12, when the user selects a specific group member in FIG. 11, an invitation message is sent to the terminal of the selected group member. That is, when the user selects a specific group member, the specific group member is correlated with communication information related to the terminal of the selected group member, and an invitation message may be automatically sent via the correlated communication information (e.g., phone number or email). The invitation message may be shown to the terminal as a pop-up depending on the user settings, along with keywords of an event related to this message and the date of occurrence of the event.

Upon receiving the invitation message, the group member may join the group through a “Join” icon or reject the invitation through a “Reject” icon.

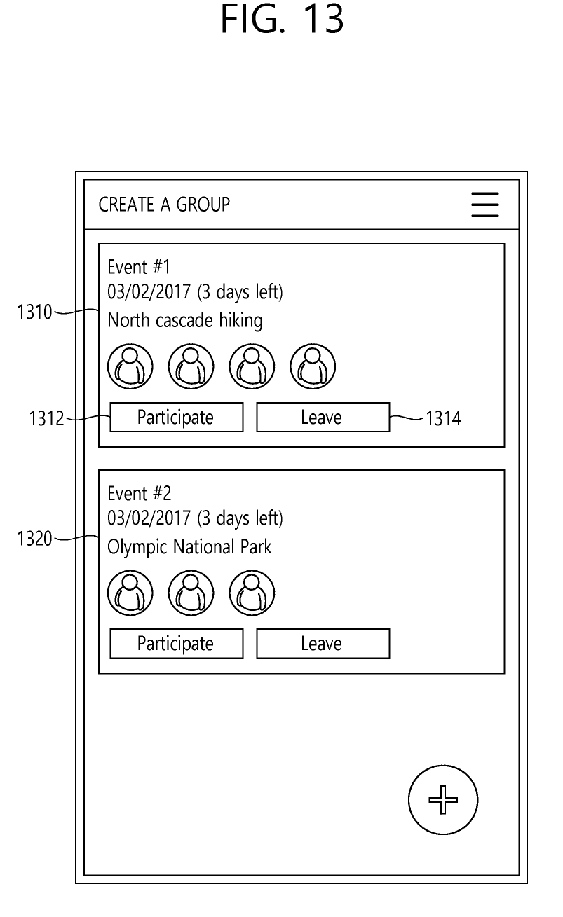

FIG. 13 is an illustration exemplifying a display screen that displays a list of events related to a specific user.

Referring to FIG. 13, once the user logs in to an application according to an exemplary embodiment of the present invention, events related to this account are shown. When groups and events are created, information (e.g., event indices, event dates, information about group members participating in the events) related to the created groups and events is stored in the terminal and/or the server. Accordingly, when the user executes the application and logs in to it, the events the user's account are participating in are shown.

In the exemplary embodiment of the present invention illustrated in FIG. 13, there are two events 1310 and 1320. On the event display screen, the user may keep participating in an event through the icon 1312 for letting the user keep participating or may leave the event through the icon 1314 for letting the user leave the event.

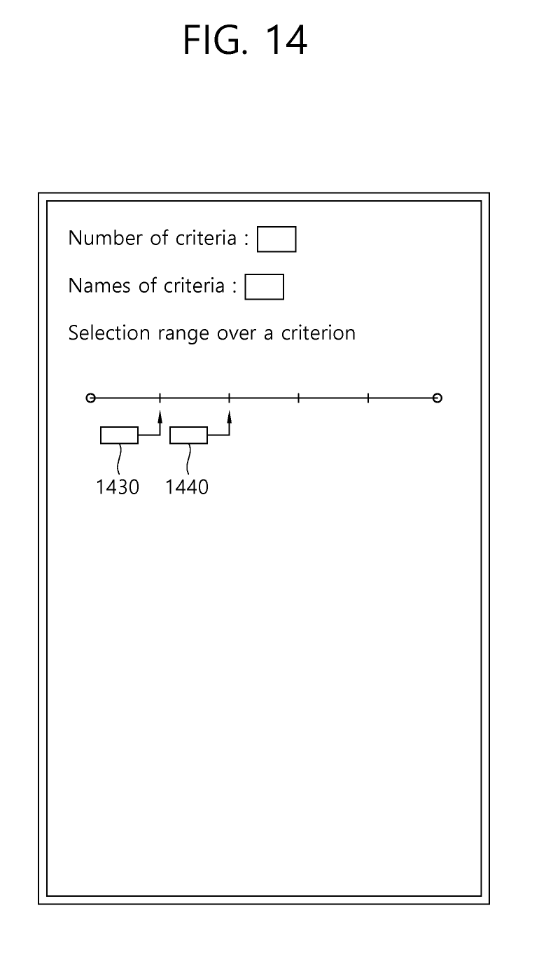

FIG. 14 is an illustration exemplifying an interface for setting up a specific event.

Referring to FIG. 14, the user has to choose group members when creating an event, and at the same time they better decide on decision criteria. The user may decide the type of the event first—for example, a hiking trail, a restaurant, or a tourist attraction. Once the type of a larger category is decided, the types of subsets of this category may be decided. For example, there may be various subcategories like Korean, Chinese, Japanese, and American within a restaurant category. Such a category may have a depth of multiple layers, and the user does not have to break the category into too-fine categories. This may be decided according to the user's preferences.

Once the category of a specific destination is decided, default decision criteria corresponding to this category may be given—for example, in the case of a restaurant, price range, review ratings, the number of reviews, distance, or estimated travel time. In some cases, one of the group members may establish the decision criteria. FIG. 14 depicts such a user interface.

First of all, the number of decision criteria may be filled in a blank space 1410. Then, the names of the decision criteria may be filled in a blank space 1420. For example, the name of a decision criterion “price range of food” may be entered. Then, separation points 1430 and 1440 may be set on a selection range for this decision criterion. That is, when $10 is entered into the blank space 1430, the first section from the left of the scale ranges from $0 to $10. Likewise, when $20 is entered into the blank space 1440, the second section from the left of the scale ranges from $10 to $20. These ranges are not necessarily limited to amounts ordered at regular intervals. In this way, a specific user may create an event by setting a selection range related to the group members' selections.

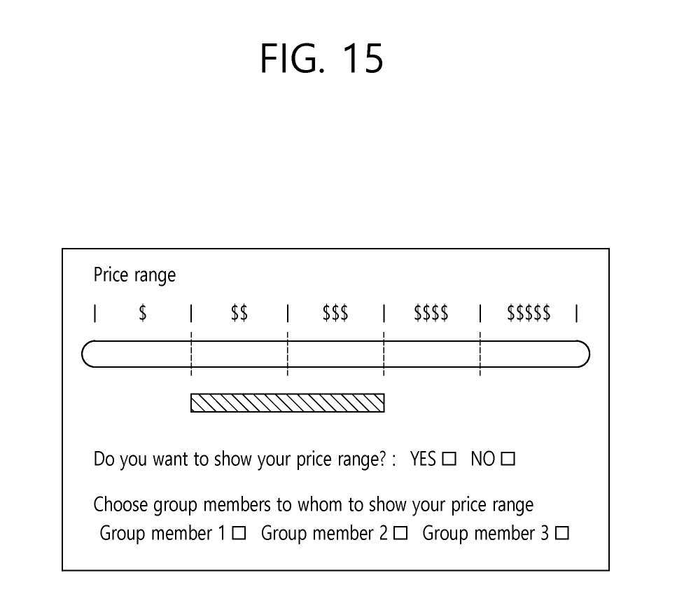

FIG. 15 is an illustration exemplifying an interface for selecting whether to show or hide the user's own selection range and to whom to show.

Referring to FIG. 15, the user may be reluctant to show a selection range like price to others, because this means that their financial situation would be revealed, which is directly related to privacy of individuals. Accordingly, the user may select whether to show or hide over a specific decision criterion. The user may choose their price range on the interface according to the exemplary embodiment of FIG. 15 and check yes or no in the checkboxes to select whether to show or hide the price range they choose.

If the user selects to show their price range, they may select each individual group member to whom the price range will be shown.

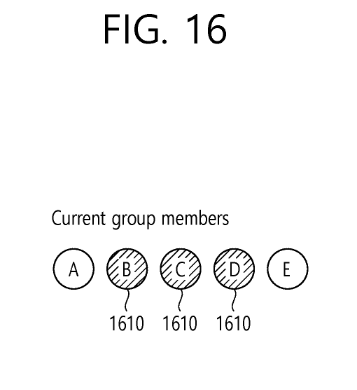

FIG. 16 is an illustration exemplifying an interface for choosing group members when the user wants to view selection ranges of only some of the group members in a specific event.

Referring to FIG.16, the terminal includes a function for presenting selection ranges of only some 1610 of the group members in a specific event. For instance, if there are too many group members (like 20 or more) and there is therefore little point in quantitatively confirming the selection ranges of these group members, only some group members who have expertise in this event may be chosen because the user might be interested only in their selection ranges. Accordingly, the user may choose to view selection ranges of only some group members, and the terminal may perform filtering only within their selection ranges and present filtered candidates. That is, presentation of candidates may be done in relation to selected group members.

According to another exemplary embodiment of the present invention, the terminal includes a function for presenting filtering ranges of group members who are not chosen.

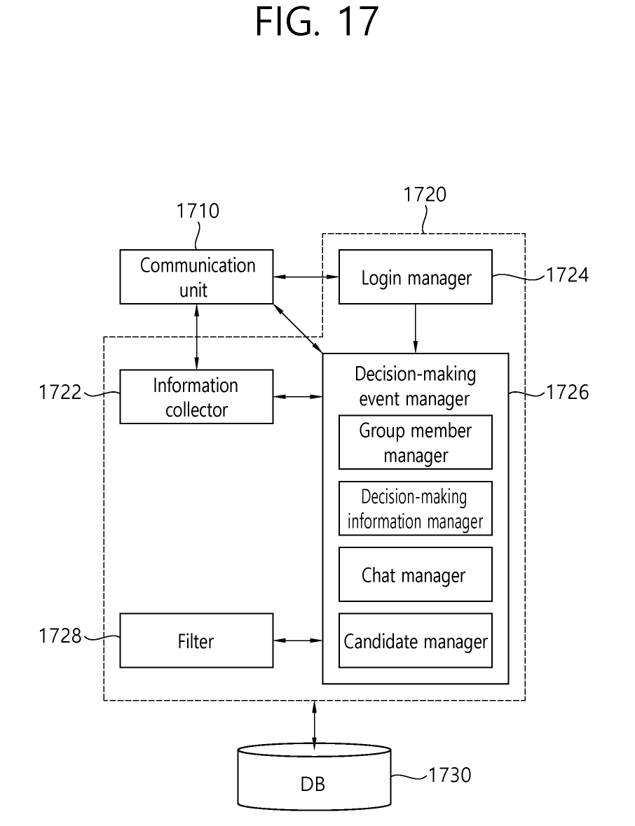

FIG. 17 is a block diagram schematically showing a configuration of a server apparatus of an information visualization system for user group decision-making according to an exemplary embodiment of the present invention.

As shown in FIG. 17, the server apparatus according to the exemplary embodiment of the present invention may include a communication unit 1710, a controller 1720, and a database 1730.

Referring to FIG. 17, the communication unit 170 receives various information from a user terminal. The communication 1710 is a communication module that receives packets over a wired or wireless network.

The controller 1720 may include an information collector 1722, a login manager 1724, a decision-making event manager 1726, and a filter 1728.

The information collector 1722 collects information received through the communication unit 1710 and provides it to the decision-making event manager 1726.

The log-in manager 1724 processes login-related information received from a terminal. It creates and manages an account for an application related to decision-making based on account creation-related information provided by the terminal. It processes the user's logins via the created account. The login manager 1724 stores an address (or addresses) related to the account in the database 1730 by matching them with the account.

Once a login is complete, the decision-making event manager 1726 processes events related to decision-making. The decision-making event manager 1726 may include a group member manager, a decision-making information manager, a chat manager, and a candidate manager.

The group member manager manages events related to this account and groups for these events. First, the group member manager manages account-related events by indexing the events, and manages the organization of group members for each event index. For example, when a login occurs via Account A, the group member manager manages how the events related to Account A are currently going on and manages the accounts of the group members for this event.

Moreover, the decision-making information manager manages information about the number of decision criteria for an event, the definitions of the decision criteria, and the setup of selection ranges over decision criteria. Also, it collects and manages selection ranges the group members select for the event, and lets the group members to share them. In this case, the group members share information according to the settings for showing it only to particular group members and/or the settings for hiding it from particular group members.

Further, when switched to the chat screen, the chat manager provides chat messages sent and received between the group members to their terminals.

The candidate manager extracts matching candidates based on selection information filtered through the filter 1728. Then, it manages the extracted candidates by relating them with the event, and provides related information to the terminals of the group members.

The filter 1728 is used when selection ranges need to be filtered by the server side according to the user settings. Like the one on the user's terminal, the filter 1728 includes an ego-centered filter, a group-exclusive filter, and a group-inclusive filter, and filtering is done properly as the user chooses. Filtered candidates may be provided to the candidate manager.

Information about a filtered selection range, as well as candidate information extracted by the decision-making event manager 1726, is provided to the terminals of the group members through the communication unit 1710.

The database 1730 stores various information related to the decision-making application. The database 1730 may be internal or external to the server.

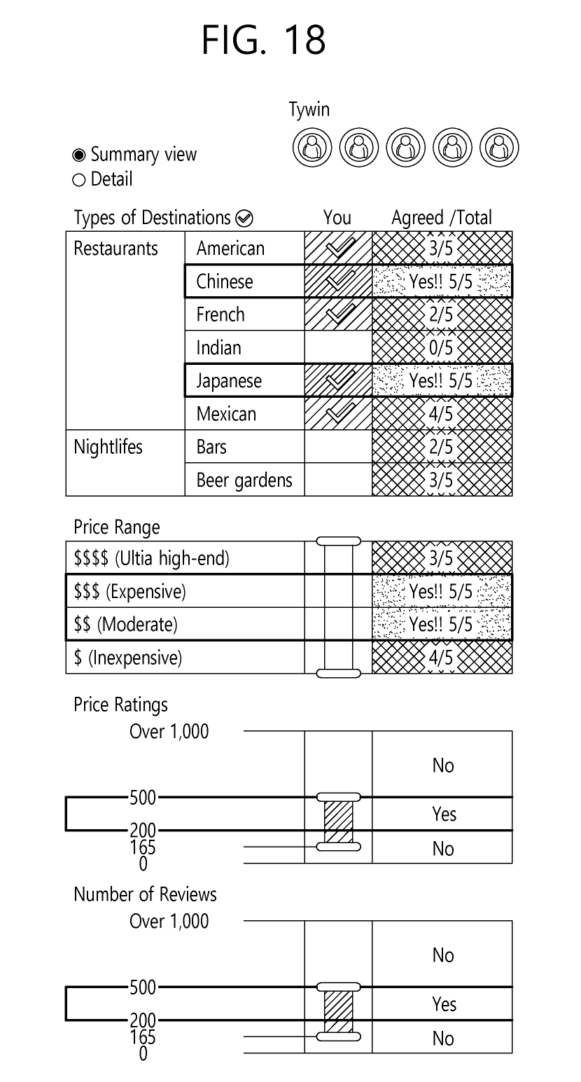

FIG. 18 is a view showing a summary view (also referred to as a simple view) screen of an information visualization method for user group decision-making according to another exemplary embodiment of the present invention.

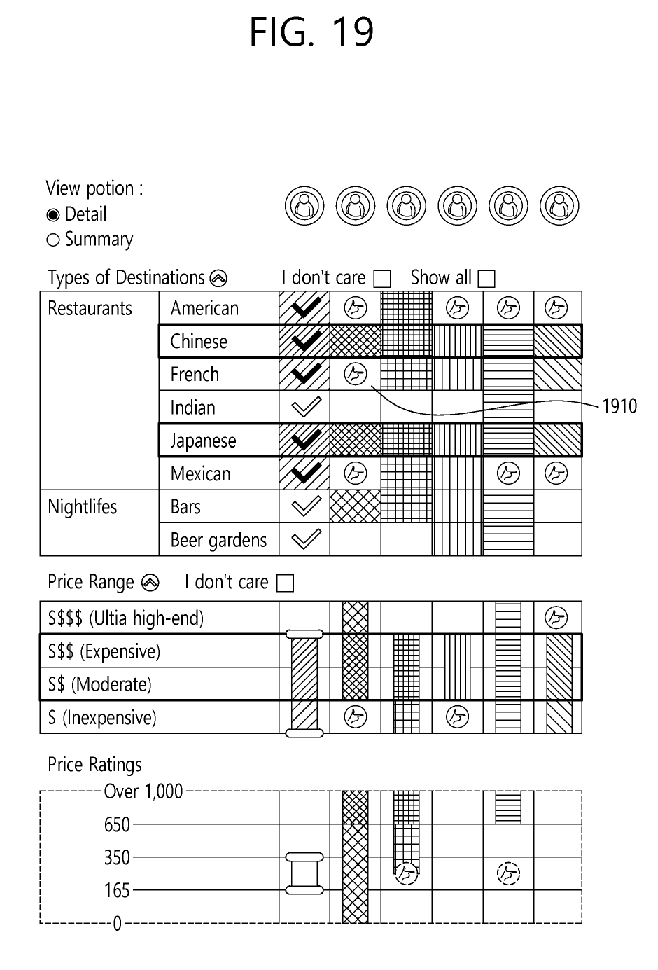

Referring to FIG. 18, the terminal may present a summary of information related to various types of decision-making events. For events on a dichotomous scale, the terminal may show how many group members select yes (agree) or no (disagree). In the case of a nominal method, for events on a categorical scale, the terminal may show how many group members agree or disagree on a specific dimension. For events on a quantitative scale, a summary view of the number of group members within each selection range may be presented. The number of group members is represented as the percentage of group members who select a specific range out of all group members. In such instances, the user's own selections may be displayed as well so as to make comparisons and distinctions between their own opinions and others'. In a summary view, if the user wants to see more details on a specific dimension, they can click on the corresponding part. Then, a screen will spread out to show information about this dimension. This will be described with reference to FIG. 19.

FIG. 19 is a view showing a screen (also referred to as a detail view) that appears when there is a request to show details on a specific dimension in the summary view screen of FIG. 18.

Referring to FIG. 19, a dimension in the above summary view of FIG. 18 may be magnified to present a screen showing each group member's decisions in a table format. As described above, each group member's decisions may be color-coded to match the group members.

If the user wants to request a group member in a specific group to make a change to a specific decision criterion, they can tap a box related to requesting a change in the table. Then, a request may be automatically delivered to that group member via a chat or a separate ping cue. For instance, in a case where unanimous consent can be reached if only the one who disagrees changes their mind over a decision criterion related to the type of restaurant (French), the user may send a request asking that person to agree with French restaurants via a chat or a ping cue by clicking on the button 1910 in that group member's blank space related to French restaurants. This can be done by extracting that group member's contact via the button click and automatically creating a request message.

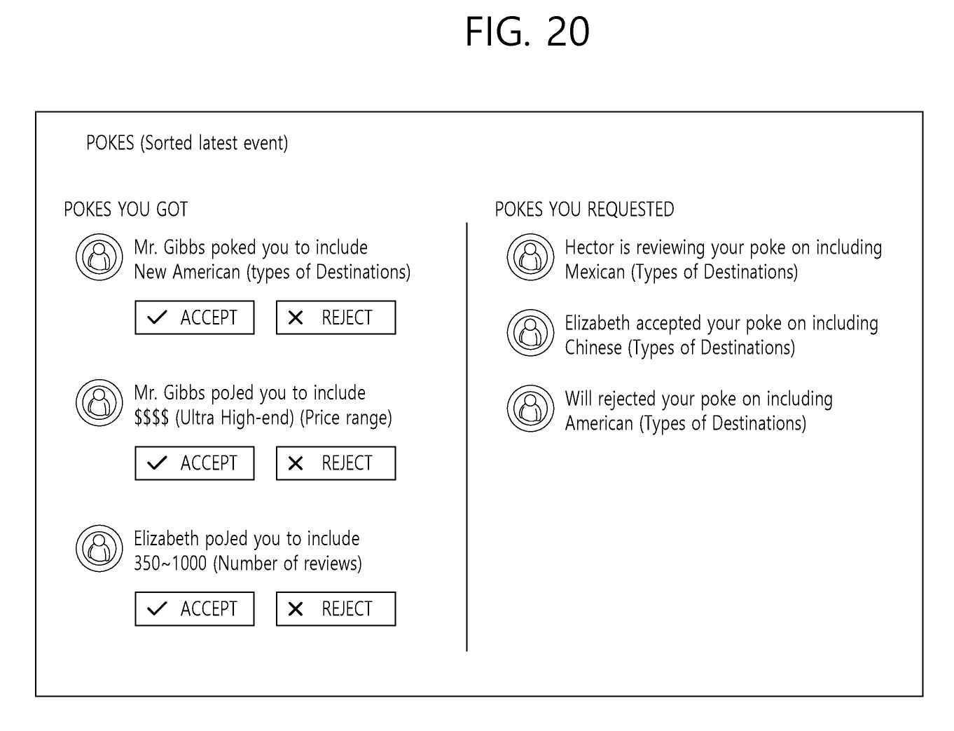

FIG. 20 is a view exemplifying ping cue messages.

Referring to FIG. 20, a message asking a specific group member to include a particular restaurant type (“New American” in the exemplary embodiment of FIG. 20) is delivered to that group member. Also, the user may receive a ping que from other group members and change their own selection range in response to the received message.

The system or apparatus described above may be realized by hardware elements, software elements and/or combinations thereof. For example, the system, apparatus, and components described in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or more software applications running on the OS. Further, the processing unit may access, store, manipulate, process, and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Further, the processing unit may have a different processing configuration, such as a parallel processor.

Software may include computer programs, codes, instructions, or one or more combinations thereof and configure a processing unit to operate in a desired manner or independently or collectively control the processing unit. Software and/or data may be permanently or temporarily embodied in any type of machine, components, physical equipment, virtual equipment, computer storage media or units, or transmitted signal waves so as to be interpreted by the processing unit or to provide instructions or data to the processing unit. Software may be dispersed throughout computer systems connected via networks and be stored or executed in a dispersion manner. Software and data may be recorded in one or more computer-readable storage media.

The methods according to the above-described exemplary embodiments of the inventive concept may be implemented with program instructions which may be executed by various computer means and may be recorded in computer-readable media. The computer-readable media may also include, alone or in combination with the program instructions, data files, data structures, and the like. The program instructions recorded in the media may be designed and configured specially for the exemplary embodiments of the inventive concept or be known and available to those skilled in computer software. Non-transitory computer-readable media may include magnetic media such as hard disks, floppy disks, and magnetic tape; optical media such as CD ROM disks and DVDs; magneto-optical media such as floptical disks; and hardware devices which are specially configured to store and perform program instructions, such as a read-only memory (ROM), a random access memory (RAM), a flash memory, and the like. Program instructions may include both machine codes, such as produced by a compiler, and higher-level language codes which may be executed by the computer using an interpreter. The described hardware devices may be configured to act as one or more software modules to perform the operations of the above-described exemplary embodiments of the inventive concept, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

According to a method, apparatus, and system for visualizing information for user group decision-making according to one exemplary embodiment of the present invention, various candidates may be derived based on selection information group members select over a decision criterion, and each group member's preferences for the derived candidates may be visually presented within their selection ranges without relying on explicit linguistic communication, thereby helping the group to make a decision more quickly and efficiently.

What is claimed is:

1. A method for a user terminal to visualize information for making a decision in a user group including a plurality of group members, the method comprising:
inputting a selection range of a first user of the user terminal over at least one criterion related to the decision-making;
receiving information on selection ranges over at least one criterion related to the decision-making of other group members in the user group;
extracting a filtered selection range by performing filtering based on at least one of the first user's selection range and the information about other group members' selection ranges;
extracting candidates for decision-making that match the filtered selection range; and
visually presenting the extracted candidates for decision-making,
wherein at least one of preferences for the visually presented candidates and the selection ranges over at least one criterion are visually presented by matching with each group member.

2. The method of claim 1, further comprising sending information about the first user's selection range selected with input from the first user to at least one of other group members' terminals and the server.

3. The method of claim 2, wherein the first user's selection range over at least one criterion is changed while presenting information about the selection ranges of at least some of the group members over at least one criterion.

4. The method of claim 1, wherein a filter used for filtering comprises at least one among:
a first filter for filtering the candidates within the first user's selection range;
a second filter for filtering candidates that match the selection ranges of all the group members participating in decision-making; and
a third filter for presenting every candidate that matches at least one of the selection ranges of the group members participating in decision-making.

5. The method of claim 4, wherein the server or the first user selects the filter used for filtering.

6. The method of claim 1, wherein the group members participating in the decision making are assigned corresponding visual representations,
and wherein the selection ranges over the at least one criterion are displayed in a bar shape based on the corresponding visual representations.

7. The method of claim 6, wherein a selection range which a plurality of group members select over a specific criterion is displayed in a single bar,
wherein the single bar is indicated with a visual representation that indicates a scent based on the number of group members for each range.

8. The method of claim 1, wherein the group members participating in the decision making are assigned corresponding visual representations,
and wherein the preferences on the candidates are presented by marking the corresponding visual representations near the candidates.

9. The method of claim 1, wherein an interface for selecting a criterion over which the first user of the user terminal hides the selection range from other group members' terminals is provided.

10. The method of claim 1, wherein an interface for choosing group members to allow the first user to show or hide the selection range over at least one criterion to or from the terminals of the group members is provided.

11. The method of claim 1, wherein a plurality of group members included in a first user group for making a first decision are organized by sending an invitation message and accepting the invitation.

12. The method of claim 1, wherein the first user group is a user group for making a first decision, one user of which is associated with a plurality of user groups for making multiple decisions, and the plurality of user groups associated with the one user are presented in a list.

13. The method of claim 1, wherein the preferences on the candidates are presented in a list view or map view.

14. The method of claim 13, wherein, in the map view, the preferences on the candidates are indicated by a cluster bubble.

15. The method of claim 1, wherein the selection range comprises at least one among a Boolean selection range, a categorical selection range, and a quantitative selection range.

16. The method of claim 1, wherein at least one of the selection ranges of other group members over at least one criterion is visualized in a summary view which is presented based on the number of group members who agree with the at least one selection range and the number of group members who disagree with the at least one selection range.

17. The method of claim 16, wherein, in response to a request for detailed information about a specific selection range in the summary view, a detail view which presents whether each group member agrees over the specific selection range or not is visualized.

18. An apparatus for visualizing information for making a decision in a user group including a plurality of group members, the apparatus comprising:
an input unit that inputs a selection range of a first user of the user terminal over at least one criterion related to the decision-making;
a communication unit that receives information about selection ranges over at least one criterion related to the decision-making of other group members in the user group;
a controller that extracts a selection range filtered based on at least one of the first user's selection range and the information about other group members' selection ranges and extracting candidates for decision-making that match the filtered selection range; and
a display unit that visually presents the confirmed candidates,
wherein at least one of the preferences for the candidates and the selection ranges over the at least one criterion are visually presented by matching with each group member.

19. An operation method of a server providing information for making a decision in a user group including a plurality of group members, the method comprising:
receiving each group member's selection range from the user terminals of the plurality of group members over at least one criterion related to the decision-making;
extracting a filtered selection range by performing filtering based on information about at least one of the selection ranges of the plurality of group members;
extracting candidates for decision-making that match the filtered selection range; and
providing the extracted candidates for decision-making to the terminal of at least one of the plurality of group members through the communication unit,
wherein at least one of preferences for the candidates and the selection ranges over at least one criterion are visually presented by matching with each group member.

20. A server apparatus for providing information for making a decision in a user group including a plurality of group members,
the sever apparatus comprising:
a communication unit that receives each group member's selection range from the user terminals of the plurality of group members over at least one criterion related to the decision-making;
a filter that extracts a filtered selection range by performing filtering based on information about at least one of the selection ranges of the plurality of group members; and
a decision-making event manager that extracts candidates for decision-making that match the filtered selection range,
wherein the extracted candidates for decision-making are provided to the terminal of at least one of the plurality of group members through the communication unit,
and wherein at least one of preferences for the candidates and the selection ranges over at least one criterion are visually presented by matching with each group member.
